(19) United States
(12) Patent Application Publication
(10) Pub. No.: US 2017/0187641 A1
(43) Pub. Date: Jun. 29, 2017

(54) SCHEDULER, SENDER, RECEIVER, NETWORK NODE AND METHODS THEREOF

(71) Applicant: HUAWEI TECHNOLOGIES CO., LTD., Shenzhen (CN)

(72) Inventors: Henrik LUNDQVIST, Krista (SE); Tao CAI, Krista (SE)

(73) Assignee: HUAWEI TECHNOLOGIES CO., LTD., Shenzhen (CN)

(21) Appl. No.: 15/460,944

(22) Filed: Mar. 16, 2017

Related U.S. Application Data
(63) Continuation of application No. PCT/EP2014/069702, filed on Sep. 16, 2014.

(51) Int. Cl. H04L 12/863; H04L 12/26

(52) U.S. Cl. CPC H04L 47/621; H04L 43/0888

(57) ABSTRACT

The present application relates to a scheduler and a sender and a receiver. The scheduler (100) comprising a processor (101) and a transceiver (103); the transceiver (103) being configured to receive a first signal from a sender-receiver pair (600), wherein the sender-receiver pair (600) comprises a sender (200) and a receiver (300), the first signal comprises at least one first parameter indicating a congestion metric for a communication path between the sender (200) and the receiver (300) of the sender-receiver pair (600), and wherein the communication link is part of the communication path; and the processor (101) being configured to schedule the resources of the communication link based on the at least one first parameter.

### CROSS-REFERENCE TO RELATED APPLICATIONS

This application is a continuation of International Application No. PCT/EP2014/069702, filed on Sep. 16, 2014, the disclosure of which is hereby incorporated by reference in its entirety.

### TECHNICAL FIELD

The present application relates to a scheduler, a sender, a receiver, and a network node for communication systems.

Furthermore, the present application also relates to corresponding methods, a computer program, and a computer program product.

### BACKGROUND

One of the main performance problems observed in current wireless networks is the high packet latency that is often observed by users. The main reason for this high latency is that data packets are buffered for long periods before they are transmitted. In general there is a tradeoff between latency and link utilization in wireless networks, and wireless networks are often engineered to have high utilization and low packet loss rates, which tend to result in high packet latency.

With well designed transport protocols and active queue management the tradeoff between delay and utilization can be controlled and more efficient working points may be achieved compared to less well designed implementations. How a queue for data packets is managed determines the packet delay, packet loss and possibly explicit congestion marking for packets in the queue, which are inputs to the congestion control algorithms of the transport protocols. Therefore there are considerable ongoing efforts on designing new solutions for both transport protocols and queue management.

In base stations it is common that packets for each user is queued in a separate queue, and a scheduler determines from which queue a packet shall be transmitted at every transmission opportunity. This means that the queuing time for a packet is only dependent on the number of packets from the same user that are in the queue and the service rate of the queue. Only the service rate depends on other users. A good design of queue management and scheduling for this case is an important enabler for efficient low latency communication in wireless networks.

The scheduling algorithms can be seen as variations of round-robin, maximum throughput and different fair queuing algorithms. In general the network determines the criterion for the scheduling, and the users only see the resulting delay and throughput. However, the networks normally support multiple priority classes of traffic which allows the users to select a class that provide a good enough quality, and some classes allow resources to be reserved.

The queue management decides how many packets can be stored in each queue and which packets to drop when the queue is full. The length of the queue and the rate of the packet drops are interpreted by transport protocols as implicit feedback signals which are used to control the sending rate. Therefore, active queue management can provide such feedback in ways that should make the network work better. Active queue management can also provide explicit feedback signals by marking packet with explicit congestion notification bits. So far it has been stated in Internet Engineering Task Force (IETF) specifications that such Explicit Congestion Notification (ECN) marks should be treated the same way as dropped packets.

Moreover, there are also efforts to allow congestion to be used explicitly in traffic management by exposing the congestion levels of the rest of the path to the upstream network elements in the Congestion Exposure (CONEX) working group of IETF. This would enable traffic management solutions that allow traffic with different rate requirements to share the network resources in ways that are in some sense optimal from a network utility maximization perspective. In a proposed optimization problem formulation the congestion signal conveys the shadow price of the resources that are shared between network users. The resulting equilibrium between network feedback and the congestion control algorithms should therefore result in an optimal solution. However, when different transport protocols in the same network use different congestion signals this does not hold. Therefore, deployment of ECN with different semantics than packet loss needs to be done carefully.

Many of the more recent proposals for end-to-end congestion control mechanisms in transport protocols rely on packet delay as a signal of congestion, since this gives a much more fine-grained feedback than packet loss.

In 3GPP there is an ongoing study item on system enhancements for user plane congestion management. A number of solutions have been proposed that extend the current Evolved Packet System (EPS) core network and Radio Access Network (RAN) functionality to manage severe congestion events. Severe congestion events is a quite different scope from congestion and traffic management under normal network conditions, where congestion feedback is a tool to achieve high throughput, which is an objective of the present application. Building on the IETF solutions also allows support for good end-to-end performance.

Active Queue Management (AQM) has been an active research field for more than two decades, and numerous solutions have been proposed. It has been found that it is important both to keep the queues short with AQM policy and isolation of different flows by means of using separate queues. A solution that combines stochastic fair queuing and codel AQM has been implemented in Linux and is promoted in IETF under the name fq_codel. The stochastic fair queuing uses a hash function to distribute flows randomly into different queues which are served by round robin scheduling. Codel is an AQM algorithm that uses time stamps to measure the packet delay through a queue, and probabilistically drops or marks packets from the front of the queue as a function of the observed delay.

Other solutions proposed in the research community have tried to address the dual requirements by applications on delay and transmission rate by allowing applications a limited choice of low delay classes.

CONEX has the ability to support signaling to upstream network nodes about downstream congestion, i.e. congestion on the rest of the path. According to most of the proposed signaling solutions ECN marks and packet losses will be signaled separately. This is an enabler that allows ECN marking based congestion control to deviate from packet loss based congestion control, and hence allows an evolution of new congestion control algorithms.

Although good performance has been reported for fq_codel, it may not be ideally suited for cellular networks, since specific queues that are deterministically assigned for each user or bearer are typically supported in cellular network equipment. Rather than a stochastic queuing it is useful to consider that users are allocated deterministically to queues and control the scheduling of the queues to support differentiation both of rate and delay. With the support of CONEX it is feasible to manage traffic within one of multiple classes based on the contribution to congestion.

There is currently no solution that utilizes these mechanisms to allow each user/flow to achieve both delay that is isolated from competing traffic and possibility to independently influence the transmission rate. In a network node, such as a base station, a NB, an eNB, a gateway, a router, a Digital Subscriber Line Access Multiplexer (DSLAM), an Optical Line Terminal (OLT), a Cable Modem Termination System (CMTS) or a Broadband Remote Access Server (B-RAS), with user specific queuing there is an opportunity to support both isolated delays and user specific sending rates, but this requires a suitable way of adapting the scheduling.

### SUMMARY

An objective of embodiments of the present application is to provide a solution which mitigates or solves the drawbacks and problems of conventional solutions.

The above objectives are solved by the subject matter of the independent claims. Further advantageous implementation forms of the present application can be found in the dependent claims.

According to a first aspect of the application, the above mentioned and other objectives are achieved with a scheduler for scheduling resources of a communication link shared by a plurality of sender-receiver pairs, the scheduler comprising a processor and a transceiver; the transceiver being configured to

receive a first signal from a sender-receiver pair, wherein the sender-receiver pair comprises a sender and a receiver, the first signal comprises at least one first parameter indicating a congestion metric for a communication path between the sender and the receiver of the sender-receiver pair, and wherein the communication link is part of the communication path; and the processor being configured to

schedule the resources of the communication link based on the at least one first parameter.

It should be noted that one or more first signals comprising the first parameter may be received by the scheduler. Further, each first signal may comprise one or more first parameters which means that one first parameter may relate to one congestion metric for the communication path whilst another first parameter may relate to another congestion metric for the communication path.

An “or” in this description and the corresponding claims is to be understood as a mathematical OR which covers “and” and “or”, and is not to be understand as an XOR (exclusive OR).

An advantage with the sender or the receiver sending the present first signal to the scheduler is that the sender or the receiver may signal varying congestion requirements to the scheduler so that e.g. the serving rate or other transmission parameters related to the resources of the communication link can be adapted to the requirements of each sender-receiver pair by the scheduler.

Further, the features of the scheduler according to the present application allow adaptive control of both delay and transmission rate on the communication link that can react to changes in channel quality as well as the application sending rate. The present solution can be used end-to-end since it is designed to work as an evolution of common conventional transport and signaling protocols. This makes the present solution a favorable solution also for early deployment in a single network domain, for example it can be deployed initially in mobile networks. In a second step the present solution could be deployed in the rest of the Internet and support the same traffic management solution to the networks that send traffic into the network domain.

Moreover, traffic management policies based on congestion volume can be implemented which allows more efficient utilization of the network while maintaining a meaningful fairness between different applications and transport protocols.

In a first possible implementation form of the scheduler according to the first aspect, the congestion metric is a congestion credit metric indicating an amount of congestion in the communication path accepted by the sender, or a congestion re-echo metric indicating congestion of the communication path between the sender and the receiver wherein the communication path is an end-to-end communication path.

An advantage with the first implementation form is that these congestion metrics can be used for the purpose of implementing policies for network usage rather than only relying on policies for the data volume. Applying congestion exposure signaling mechanisms as defined by IETF, congestion volume based policies can be implemented based on the congestion of the end-to-end path. Such policies have the advantage that they only limit the sending rates when the network is congested, which allows an efficient utilization of the network by lower priority traffic during periods with low load.

In a second possible implementation form of the scheduler according to the first implementation form, the processor further is configured to

schedule the resources of the communication link based on a difference between the congestion credit metric and congestion re-echo metric.

An advantage with the second implementation form is that the scheduler can change the scheduled rate for a sender-receiver pair in proportion to how much excess congestion credit metric the sender-receiver pair is signalling, with respect to the actual end-to-end congestion volume as indicated by the congestion re-echo metric. The sender-receiver pairs can therefore signal how much additional congestion volume they can accept.

In a third possible implementation form of the scheduler according to the any of the previous implementation forms of the scheduler according to the first aspect or the scheduler as such, each sender-receiver pair is associated with at least one transmission queue; and wherein the processor further is configured to

schedule the resources of the communication link to transmission queues.

An advantage with the third implementation form is that the traffic of data packets from one or more sender-receiver pairs can be stored in queues, so that a network node with a scheduler can be implemented with a number of queues which results in an acceptable complexity.

In a fourth possible implementation form of the scheduler according to the third implementation form, data packets of each transmission queue are associated with a bearer, a session or a flow, and wherein each bearer, each session and each flow have a priority class among a plurality of priority classes; and wherein the processor further is configured to

schedule the resources of the communication link based on the at least one first parameter and the priority classes.

An advantage with the fourth implementation form is that the network with the present scheduler can use different quality classes to support service with different requirements, e.g. delay, while allowing the sender-receiver pairs to signal their preferences for higher or lower transmission rates using the present congestion metrics.

In a fifth possible implementation form of the scheduler according to the any of the previous implementation forms of the scheduler according to the first aspect or the scheduler as such, the transceiver further is configured to

receive the first signal from the sender.

An advantage with the fifth implementation form is that congestion based policies can be implemented by the sender and policed at the network ingress where the sender is connected to the network. By policing at the beginning of the communication path the data packets that will be dropped by the policer do not cause any unnecessary load in the network.

In a sixth possible implementation form of the scheduler according to the any of the previous implementation forms of the scheduler according to the first aspect or the scheduler as such, the transceiver further is configured to

transmit a scheduling information signal to the plurality of sender-receiver pairs (e.g. to the sender, to the receiver, or both to the sender and the receiver), wherein the scheduling information signal indicates that the scheduler uses the at least one first parameter when scheduling the resources of the communication link.

An advantage with the sixth implementation form is that the sender-receiver pairs are aware of whether there is a network node (with the present scheduler) on the path that will adapt the scheduling according to the present congestion metric signaling by receiving the scheduling information signal. Each sender-receiver pair can therefore select to implement traffic control algorithms with or without signaling to the scheduler depending on whether the congestion metric signaling of the first signal will be used by any scheduler in the network.

In a seventh possible implementation form of the scheduler according to the any of the previous implementation forms of the scheduler according to the first aspect or the scheduler as such, the processor further is configured to

derive a serving rate for the communication path based on the at least one first parameter; and the transceiver further is configured to

transmit a scheduling signal to the sender, wherein the scheduling signal comprises an indication of the serving rate.

An advantage with the seventh implementation form is that the sender can be informed directly about the serving rate which is advantageous for some classes of transport protocols, in particular protocols that rely on explicit rate signaling. The scheduler in an access network may also inform a directly connected sender about the serving rate using e.g. a link layer protocol.

In an eight possible implementation form of the scheduler according to the any of the previous implementation forms of the scheduler according to the first aspect or the scheduler as such, the transceiver further is configured to

receive a second signal comprising at least one second parameter, wherein the at least one second parameter is a channel quality parameter associated with the communication link for the sender-receiver pair; and wherein the processor further is configured to

schedule the resources of the communication link based on the at least one first parameter and the at least one second parameter.

An advantage with the eight implementation form is that the scheduler can use scheduling algorithms that implements preferred trade-offs between spectral efficiency and support for the request rates of each sender-receiver pair.

According to a second aspect of the application, the above mentioned and other objectives are achieved with a sender or a receiver of a sender-receiver pair, the sender being configured to transmit data packets to the receiver over a communication path via a communication link, wherein the communication link is part of the communication path and shared by a plurality of sender-receiver pairs, and wherein the resources of the communication link is scheduled by a scheduler; the sender or the receiver comprising a processor and a transceiver; the processor being configured to

monitor a congestion level of the communication path;

determine at least one first parameter based on the monitored congestion level, wherein the at least one first parameter indicates a congestion metric for the communication path; and the transceiver being configured to

transmit a first signal comprising the at least one first parameter to the scheduler.

An advantage with the second aspect is that the sender or the receiver may signal varying requirements to the scheduler so that serving rate or other transmission parameters can be adapted to requirements of communication services between the sender and the receiver, whilst taking into account the congestion level of the communication path.

In a first possible implementation form of the sender or the receiver according to the second aspect, the congestion metric is a congestion credit metric indicating an amount of congestion in the communication path accepted by the sender, or a congestion re-echo metric indicating end-to-end congestion of the communication path between the sender and the receiver.

An advantage with the first implementation form is that these congestion metrics can be used for the purpose of implementing policies for the network usage. The sender can therefore apply congestion control algorithms that provide good service while avoiding causing excessive congestion.

In a second possible implementation form of the sender or the receiver according to the first implementation form of the second aspect or the sender or the receiver as such, the transceiver further is configured to

transmit an additional first signal comprising at least one updated first parameter to the scheduler if a serving rate, a throughput or a packet delay of the communication path does not meet a serving rate threshold, a throughput threshold or a packet delay threshold, respectively.

An advantage with the second implementation form is that the sender can reactively request the scheduler to increase the serving rate if the quality of service received is insufficient due to the fact that one or more thresholds are not met. This allows the sender to implement quality of service supporting closed loop congestion control algorithms.

In a third possible implementation form of the sender or the receiver according to the second implementation form of the second aspect, the processor further is configured to

determine the at least one updated first parameter based on a network policy, wherein the network policy limits a total congestion volume of network traffic from the sender or network traffic to the receiver during a time period.

An advantage with the third implementation form is that the sender is constrained to follow network policies provided by the network on the amount of congestion that the sender is allowed to contribute to. The network may enforce policies that guarantee a stable network operation with a distribution of resources that is fair according to policies defined according to the congestion metrics.

In a fourth possible implementation form of the sender or the receiver according to any of the previous implementation forms of the second aspect or the sender or the receiver as such, wherein the transceiver further is configured to

receive a scheduling signal from the scheduler, wherein the scheduling signal comprises an indication of a serving rate for the communication path, and

transmit data packets to the receiver over the communication path at the serving rate.

An advantage with the fourth implementation form is that the sender can be informed directly about the serving rate and use this to adjust its sending rate accordingly.

According to a third aspect of the application, the above mentioned and other objectives are achieved by a method for scheduling resources of a communication link shared by a plurality of sender-receiver pairs, the method comprising:

receiving a first signal from a sender-receiver pair, wherein the sender-receiver pair comprises a sender and a receiver, the first signal comprises at least one first parameter indicating a congestion metric for a communication path between the sender and the receiver of the sender-receiver pair, and wherein the communication link is part of the communication path; and

scheduling the resources of the communication link based on the at least one first parameter.

According to a fourth aspect of the application, the above mentioned and other objectives are achieved by a method in a sender or a receiver of a sender-receiver pair, the sender being configured to transmit data packets to the receiver over a communication path via a communication link, wherein the communication link is part of the communication path and shared by a plurality of sender-receiver pairs, and wherein the resources of the communication link is scheduled by a scheduler; the method comprising:

monitoring a congestion level of the communication path;

deriving at least one first parameter from the monitored congestion level, wherein the at least one first parameter indicates a congestion metric for the communication path; and

transmitting a first signal comprising the at least one first parameter to the scheduler.

The advantages of the method for scheduling resources and the method in a sender or a receiver according to the third and fourth aspects are the same as those for the corresponding device claims according to the first and second aspects.

Moreover, the present application also relates to a network node and a method in such a network node.

The first network node, such as a base station, router, relay device or access node, according to the present application is a network node for a communication network, the network node comprising a plurality of queues configured to share common resources of a communication link for transmission of data packets to one or more receivers; the network node further comprising a processor and a transmitter;

wherein the processor is configured to

determine a first congestion level based on an utilization of the resources of the communication link;

mark data packets of the plurality of queues with a first marking based on the first congestion level; and for each queue:
determine a second congestion level for a queue among the plurality of queues based on a queue length of the queue, and
mark data packets of the queue with a second marking based on the second congestion level; and
   wherein the transmitter is configured to

transmit the data packets of the plurality of queues to the one or more receivers via the communication link.

An advantage of the features of the first network node this is that a sender-receiver pair will be able to distinguish whether congestion is caused by its own transmissions or by other users. The reaction to the congestion can be quite different depending on type of congestion. In particular, for self-inflicted congestion the packet delay will increase rapidly if the sender increases the transmission rate, while congestion in a shared queue will result in a weaker dependence between the sending rate and the queuing delay.

The congestion level of the shared of the resources of the communication link is determined based on the utilization of the resources of the communication link. The detailed methods for defining the congestion level may vary, but in general they will relate the demand for data transmission to the available resources of the communication link. If the resources are fully utilized, the congestion level shall reflect how much the demand exceeds the available transmission capacity. The transmission capacity of the communication link often depends on the channel quality, which may vary over time and depend on which users that are served. It is therefore practical to estimate or configure an approximate serving rate for the communication link.

In a first possible implementation form of the first network node, the data packets comprises a first header field and a second header field; and the processor further is configured to

mark the first header field with the first marking; and

mark the second header field with the second marking.

An advantage with the first possible implementation form of the first network node is that the type of congestion can be reliably observed by the receiver of the marked packets.

The second network node according to the present application is also a network node for a communication network, the network node comprising a plurality of queues configured to share common resources of a communication link for transmission of data packets to one or more receivers; the network node further comprising a processor and a transmitter;

wherein the processor is configured to

determine a first congestion level based on an utilization of the resources of the communication link;

mark data packets of the plurality of queues with a first marking based on the first congestion level; and for each queue:
determine a second congestion level for a queue among the plurality of queues based on a queue length of the queue, and
drop data packets of the queue according to a probability based on the second congestion level; and
   wherein the transmitter is configured to

transmit the data packets of the plurality of queues, which have not been dropped, to the one or more receivers via the communication link.

An advantage of the features of the second network node is that two types of congestion can be signaled without requiring new fields in the packet headers. Therefore, the solution could be implemented using currently existing ECN marking in IP headers.

In a second possible implementation form of the first network node or a first possible implementation form of the second network node, each queue has a priority class among a plurality of priority classes, and wherein the processor further is configured to

determine a first congestion level for each priority class.

An advantage with this is that the congestion level of the shared resources can be defined in a network node with multiple quality of service classes.

In a third possible implementation form according to the first or the second possible implementation forms of the first network node or the first possible implementation form of the second network node, the processor further is configured to

mark data packets of the plurality of queues with a first marking based on a first congestion level for a priority class and further first congestion levels for priority classes below the priority class.

This has the advantage that the first marking reflects the impact that packets transmitted in higher priority classes have on the congestion also in lower priority classes. It also allows the network to apply common policies for traffic in multiple priority classes.

The present application also relates to a first method in a network node for a communication network, the network node comprising a plurality of queues configured to share common resources of a communication link for transmission of data packets to one or more receivers; the method comprising

determining a first congestion level based on an utilization of the resources of the communication link;

marking data packets of the plurality of queues with a first marking based on the first congestion level; and for each queue:
determining a second congestion level for a queue among the plurality of queues based on a queue length of the queue, and
marking data packets of the queue with a second marking based on the second congestion level; and

transmitting the data packets of the plurality of queues to the one or more receivers via the communication link.

The present application also relates to a second method in a network node for a communication network, the network node comprising a plurality of queues configured to share common resources of a communication link for transmission of data packets to one or more receivers; the method comprising

determining a first congestion level based on an utilization of the resources of the communication link;

marking data packets of the plurality of queues with a first marking based on the first congestion level; and for each queue:
determining a second congestion level for a queue among the plurality of queues based on a queue length of the queue, and
dropping data packets of the queue according to a probability based on the second congestion level; and

transmitting the data packets of the plurality of queues to the one or more receivers via the communication link.

The present application also relates to a computer program, characterized in code means, which when run by processing means causes said processing means to execute any method according to the present application. Further, the application also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the present application will be apparent from the following detailed description.

### BRIEF DESCRIPTION OF THE DRAWINGS

The appended drawings are intended to clarify and explain different embodiments of the present application, in which:

FIG. 1 shows a scheduler according to an embodiment of the present application;

FIG. 2 shows a flow chart of a method in a scheduler according to an embodiment of the present application;

FIG. 3 shows a sender and a receiver according to an embodiment of the present application;

FIG. 4 shows a flow chart of a method in a sender or a receiver according to an embodiment of the present application;

FIG. 5 illustrates a plurality of sender-receiver pairs using a common communication link;

FIG. 6 illustrates an embodiment of the present application;

FIG. 7 shows a network node according to an embodiment of the present application;

FIG. 8 shows a flow chart of a method in a network node according to an embodiment of the present application;

FIG. 9 illustrates an embodiment of marking and scheduling according to the present application;

FIG. 10 illustrates another embodiment of marking and scheduling according to the present application; and

FIG. 11 illustrates yet another embodiment of marking according to the present application.

### DETAILED DESCRIPTION

In a network node with individual queues for each user or bearer or flow, the queuing delay experienced by a user is essentially self-inflicted, i.e. data packets are delayed be queuing behind packets that are sent by the same user (or bearer or flow). By adapting the sending rate to the scheduled resources the end-hosts can maintain a low delay when the delay is self-inflicted. With most scheduling regimes a user cannot increase its share of the common resources of a communication link in any simple way, as opposed to the case in a shared queue, where a user can increase its throughput at the expense of other users by sending at a higher rate. On the other hand an end host does not have control over its queuing delay in a shared queue, since the data packets are delayed also by packets transmitted by other users.

A user specific queue is a queue that only contains data packets from one user. It should be clear that a user in this case may refer to a single flow or all the flows of one user. For example bearer specific queues would be an equivalent notation, but we use the notation user specific queues for simplicity. A shared queue is a queue that does not make any difference between users. A typical example is a First Input First Output (FIFO) queue, but other queuing disciplines such as “shortest remaining processing time first” are not excluded. What is excluded is scheduling packets in an order that is determined based on the identity of the user rather than properties of the packets.

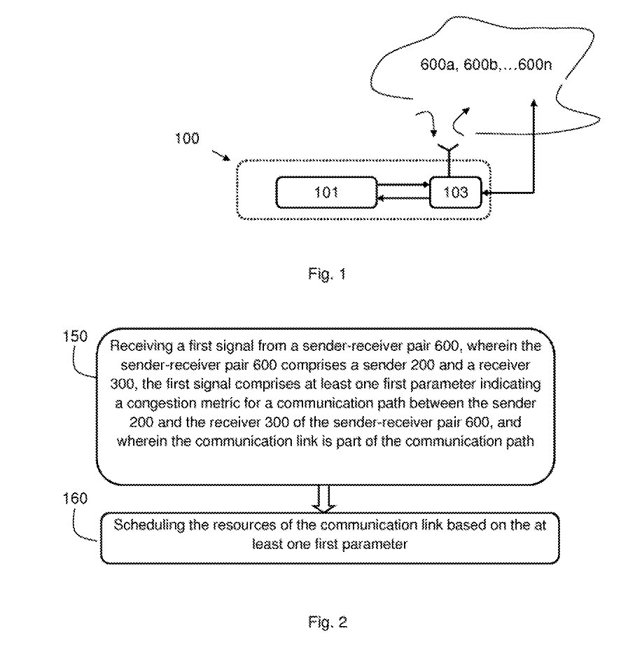

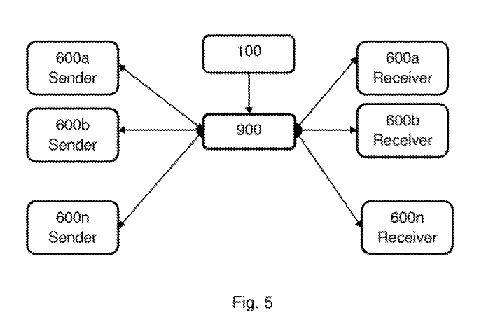

The present application relates to a scheduler 100 for scheduling resources of a communication link which is shared by a plurality of sender-receiver pairs 600a, 600b, . . . , 600n (see FIG. 5). FIG. 1 shows an embodiment of a scheduler 100 according to the present application. The scheduler 100 comprises a processor 101 and a transceiver 103. The transceiver 103 is configured to receive a first signal from a sender-receiver pair 600. The transceiver 103 may be configured for wireless communication (illustrated with an antenna in FIG. 1) and/or wired communication (illustrated with a bold line in FIG. 1).

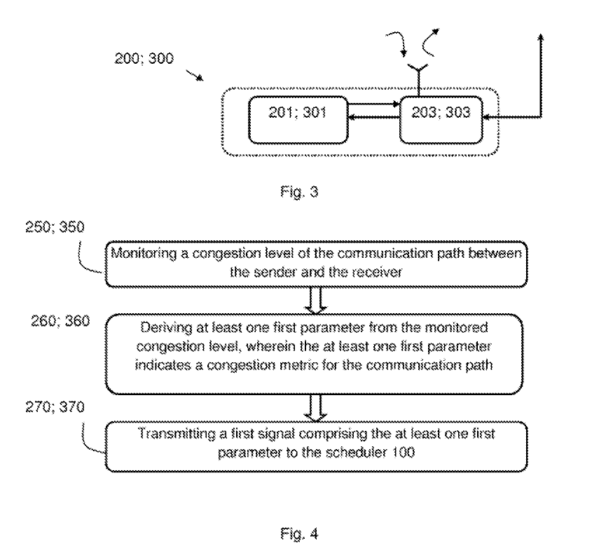

The sender-receiver pair 600 comprises a sender 200 and a receiver 300 (see FIG. 3) and the first signal comprises at least one first parameter indicating a congestion metric for a communication path between the sender 200 and the receiver 300 of the sender-receiver pair 600. The communication link 900 is part of the communication path between the sender 200 and the receiver 300. Further, the processor 101 is configured to schedule the resources of the communication link based on the at least one first parameter. This can for example be done by increasing the fraction of the common resources that are signaled to users that signals high values of a congestion metric, as will be further described in the following disclosure.

The scheduler 100 may be a standalone communication device employed in a communication network. However, the scheduler 100 may in another case be part of or integrated in a network node, such as a base station or an access point. Further, the scheduler is not limited to be used in wireless communication networks, and can be used in wired communication networks or in hybrid communication networks.

The corresponding method is illustrated in FIG. 2 and comprises: receiving a first signal from a sender-receiver pair. The sender-receiver pair comprises a sender and a receiver, and the first signal comprises at least one first parameter indicating a congestion metric for a communication path between the sender and the receiver. Also for the method the communication link 900 is part of the communication path. The method further comprises scheduling the resources of the communication link 900 based on the at least one first parameter.

The first signal is in one embodiment sent from the sender 200 of the sender-receiver pair to the scheduler. In another embodiment the first signal is sent from the receiver 300 of the sender-receiver pair to the scheduler. It is also possible that the transmission of the first signal is shared between the sender 200 and the receiver 300.

FIG. 3 shows a sender 200 or a receiver 300 according to an embodiment of the present application. The sender 200 or the receiver 300 comprises a processor 201; 301 and a transceiver 203; 303. The processor of the sender 200 of the receiver 300 201; 301 is configured to monitor a congestion level of the communication path, and to determine at least one first parameter based on the monitored congestion level. The at least one first parameter indicates a congestion metric for the communication path. Further, the transceiver 203; 303 is configured to transmit a first signal comprising the at least one first parameter to the scheduler 100 which receives the first signal, extracts or derives the first parameter and schedules the resources of the communication link 900 based on the first parameter.

FIG. 4 shows a corresponding method in the sender or the receiver of the sender-receiver pair. The method in the sender 200 of the receiver 300 comprises monitoring 250; 350 a congestion level of the communication path and deriving 260; 360 at least one first parameter from the monitored congestion level. The at least one first parameter indicates a congestion metric for the communication path. The method further comprises transmitting 270; 370 a first signal comprising the at least one first parameter to the scheduler 100.

FIG. 5 illustrates a plurality of sender-receiver pairs 600a, 600b, . . . , 600n (where n is an arbitrary integer). Each sender-receiver pair uses at least on communication path, shown with arrows, for communication between the sender 200 and the receiver. All communication paths share a communication link 900 and the present scheduler 1000 is configured to control and schedule the resources of the communication link 900. Typically, the signaling paths are the same as the paths of the data packets, and the signaling is carried as part of the packet headers. In some cases the feedback from the receiver to the sender may take a different path than the data from sender to receiver. This is generally no problem when the first signal containing the congestion parameters are sent by the sender to the scheduler, since the first signal will reach the scheduler together with the data.

According to an embodiment of the present application the congestion metric is a congestion credit metric indicating an amount of congestion in the communication path accepted by the sender 200, or a congestion re-echo metric indicating congestion of the communication path between the sender 200 and the receiver 300. Preferably, the communication path of the congestion re-echo metric is the end-to-end path between the sender 200 and the receiver 300 of the sender-receiver pair.

In this embodiment of the scheduler, the processor 101 may further be configured to schedule the resources of the communication link based on a difference between the congestion credit metric and congestion re-echo metric. Hence, at least one congestion credit metric and at least one congestion re-echo metric is received by the scheduler from the sender 200 and/or the receiver 300.

Furthermore, a network node which has multiple queues specific for different users and a scheduler 100 that schedules packets from the user queues for transmission over the common communication link 900 is considered. The congestion credit signaling from the sender 200 would be interpreted as a signal to change the serving rate of that particular user queue. This interpretation follows the logic that the sender 200 indicates with congestion credits that the sender 200 can accept higher congestion volume, which would result both in higher sending rate and the higher congestion level of the shared resource.

The scheduler 100 will therefore increase the serving rate of a specific queue at expense of the other queues when the congestion credit signals in the queue exceed the full path congestion marking of the packets traversing the queue. This requires the scheduler 100 to have an estimate of the full path congestion. If the congestion exposure marking follows the principle of sending both credit marks before congestion and re-echo signals after congestion events, the re-echo signals would indicate the congestion experienced over the full path. The re-echo signals would appear with approximately one RTT delay and the signaling may in general be inaccurate due to packet losses and limited signaling bandwidth. Hence, the estimate of how much increase in sending rate that the sender 200 actually requests needs to be estimated by the scheduler.

In one embodiment the congestion signaling is based on the proposed solutions from the work in the IETF CONEX working group, possibly with some extension for increasing the sending rate. One possible alternative is to use a congestion credit signal that is proposed to be included in the CONEX signaling. In a preferred embodiment the credit marking is re-interpreted so that when a sender 200 is sending extra credits, (exceeding the re-echo/CE) the scheduler 100 takes it as an indication that it should increase the serving rate of the specific sender. Such signals would explicitly indicate that the sender 200 is building up credits for congestion that it has not yet experienced. In the case of flow start this is intended to generate an initial credit at the audit function. The additional code point can be used as an indication that the sender-receiver pair would prefer to send at a higher rate, and accept a higher congestion level. This is to some extent analogous to starting a new flow, therefore the same signal could be utilized.

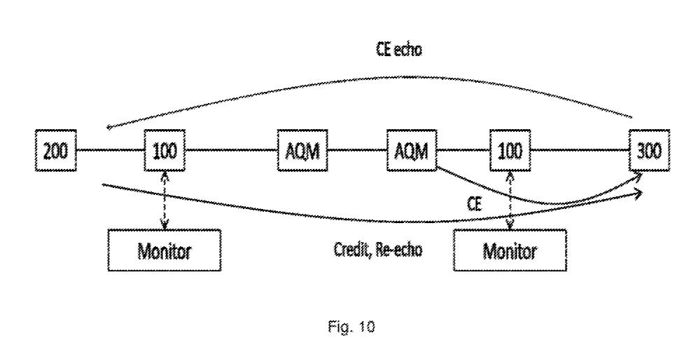

FIG. 10 illustrates an example of the present application in which the present signaling according to the application is used as input to a scheduler 100, both at the beginning of the communication path, and the end of a communication path. The monitor functions (“Monitor” in FIG. 10) in this case may implement policing at ingress, auditing at egress, but also do the measurement of the congestion signaling for the purpose of adjusting the scheduling. In some embodiments these may be separate functions, such that a network node having a scheduler 100 does not implement the audit or policing functions, while other embodiments have one monitor function that is used for multiple purposes.

The AQM in FIG. 10 can be present in any router, such as a Gateway (GW) or a base station, hence there may be multiple of AQMs along a communication path between the sender 200 and the receiver 300. The AQM applies rules to mark data packets with Congestion Experienced (CE), which is part of the Explicit Congestion Notification (ECN) bits in the IP header. A typical rule is to mark a packet with some probability that depends on the length of the average (or instantaneous) queue length in a packet buffer.

The receiver 300 in FIG. 10 sends back the CE echo to inform the sender 200 about the experienced congestion. This is done at the transport layer, so how it is done can differ between transport protocols, e.g. done immediately for each CE mark or once per Round Trip Time (RTT). The CONEX working group proposes extensions where the sender 200 marks packets with a re-echo after it receives information from the receiver 300 that CE marked packets have been received.

A policer (not shown) which could be a part of the monitor function at the sender side learns from the re-echos how much congestion there is on the communication path that the sender 200 is using, it gets a measure of the congestion volume, i.e. the number of marked packets that the sender 200 is sending. Applying policies based on the congestion volume (instead of traffic volume) has the advantage that it gives incentives to avoid sending traffic when there is congestion on the communication path. Since the policer cannot really know that the sender is marking its traffic honestly (CE echos are sent at the transport layer and are therefore difficult to observe) an audit function is needed at the end of the path to verify the correctness of the re-echo marking.

The audit function, which can be part of the monitor function at the receiver end, checks that the number of re-echo marks corresponds to the CE marks, if it observes that the sender 200 is cheating it will typically drop packets.

Since the CE marks will arrive before the re-echo marks it is necessary that the audit function allows some margins, i.e. some more CE marked packets than re-echo packets have to be allowed. However, this could be abused by a sender 200 by sending short sessions and then change identity, therefore the credit signaling (Credit in FIG. 10) is introduced. The credit signaling should be sent before the CE marks occur to provide the necessary margin in the audit function. The policer can then apply policies that take into account both the credit and re-echo signaling, which typically shall not differ much.

Typically, there is no need for any signaling mechanism to reduce the allocated resources to a user specific queue, since reducing the sending rate will have the same effect.

If there is no explicit congestion credit signaling, other embodiments with slightly different signaling mechanisms are needed to indicate the preference for higher rate. There may still be congestion exposure signaling, such as re-ECN, which can be used to indicate the preference for higher rate in less straightforward ways. At the end of the communication path, if the congestion exposure marks exceed the congestion marks over a time period, this can be taken as a sign that the specific flow prefer a higher sending rate, even if this increases the congestion level. In particular, this would be applicable for scheduling downlink traffic in an access network.

In another embodiment, with only one congestion metric parameter and where the scheduler 100 is not located at the end of the communication path, there may be additional hops that also apply congestion experienced marking. Without the combination of the congestion re-echo metric and congestion credit metric the network node would not be able to determine if the excess congestion exposure metric is compensating for congestion on the rest of the communication path in any simple way. For the uplink of an access network, the congestion of the rest of the communication path can typically be significant. One way to determine whether there is excess congestion exposure marking is to observe the returning ECN-Echo or equivalent transport level signaling. This allows the network node 800 to estimate the whole path congestion level based on the returning feedback. The main drawbacks of this solution are that it requires access to the transport layer header/signaling may not be observable due to encryption, or due to asymmetric routing. Observing transport layer feedback in the network node 800 also introduces a layer violation that increases the network node 800 complexity and implies that the network node 800 may have to be upgraded to handle new transport protocols correctly.

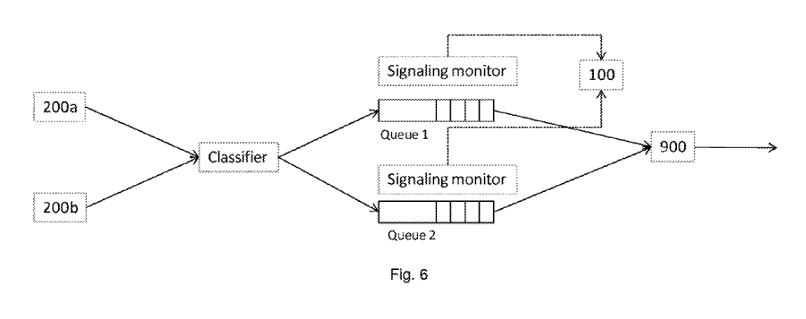

FIG. 6 illustrates schematically how an adaptive scheduler 100 according to an embodiment of the present application can be implemented. Two senders 200a and 200b sends packets through a network, typically over a different communication path for each user, to the network node with the scheduler 100. The first important function after the packets arrive at one of the network interfaces of the network node is the classifier that determines which queue each packet should be sent through. The scheduler 100 schedules data packets from multiple queues (in this case queue 1 and queue 2) over the shared resources of a shared communication link 900 to receivers (not shown). The scheduler 100 may for example be part of a base station or any other network node where the shared communication link 900 is the spectrum resources of the radio interface that can be used for transmission to or from user devices (e.g. mobile stations such as UEs). The following description use the example of downlink transmission where the data packets are queued in the base station before transmission, but those skilled in the art understand that it can also be used for uplink transmission.

Further, each queue may be associated with one or more users, bearers, sessions or flows as mentioned before. To determine which data packets belong to which queue a classifier uses some characteristics of the data packets, such as addresses, flow identifiers, port numbers or bearer identifiers to select which queue it should be stored in before being transmitted over the shared communication link. In a typical embodiment of the present application, each queue may be associated with one sender or one receiver, and the classifier may use the sender or the receiver address to determine which queue it should store the data packet in. Also a signaling monitor is associated with each queue. The signaling monitor is a function that monitors the congestion related signaling, e.g. the congestion credit, the re-echo and possibly the congestion experienced CE marks. The information about the congestion signaling for each individual queue is provided to the adaptive scheduler in the first signal as first parameters. The adaptive scheduler determines how to adjust the scheduling of the resources of the shared communication link based on the congestion signaling for each queue. The information from the signaling monitors can for example be provided to the adaptive scheduler at each scheduling interval, or it may be provided at longer update intervals depending on application.

Therefore it is realized that in one embodiment of the present application each sender-receiver pair 600a, 600b, . . . , 600n is associated with at least one transmission queue which means that the processor 101 of the scheduler 100 in this case schedules the resources of the communication link 900 to different transmission queues.

For improved quality of service the data packets of the different queues are associated with a bearer, a session or a flow which in one embodiment have a priority class among a plurality of priority classes. Hence, according to this embodiment the resources of the communication link are scheduled based on the at least one first parameter and the priority classes.

When a scheduler 100 implements multiple priority classes the scheduling of the resources of the communication link 900 within one class can be performed in a similar way as the scheduling of a single class scheduler. The scheduler 100 typically also has to take into account the sharing of the resources between the different classes. In some embodiments the scheduling within each priority class can be made based on the congestion metrics signaled by the sender-receiver pairs that use the specific class.

One or more scheduling information signals can be sent to the plurality of sender-receiver pairs 600a, 600b, . . . , 600n. The scheduling information signal indicates that the scheduler 100 uses the at least one first parameter when scheduling the resources of the communication link. In an extension the scheduler may also inform the plurality of sender-receiver pairs 600a, 600b, . . . , 600n that further parameters are used for scheduling the resources of the communication link.

An extension of the signaling that helps the higher layer protocols to use the information more efficiently would inform the end hosts about whether a scheduler is adapting the rate based on the congestion credits. This would in particular allow the congestion control algorithms to adapt their behavior to the network path. This could either be a signal from network nodes that indicate that they do not support adaptive scheduling based on the congestion credit, or in a preferred embodiment (since it is expected that most network nodes only have shared queues) a network node with the present scheduler 100 can send a signal that informs the end points of the communication paths about its ability to adjust the rate by means of the scheduling information signal. This would have the advantage that the transport protocols could use legacy algorithms when there is no support in the network for individual control of delay and rate, while in the cases where there is a scheduler using adaptive scheduling algorithms as proposed here, the transport protocols may apply more advanced algorithms, including signaling to the scheduler 100.

Another signaling performed by the scheduler 100 is signaling of a scheduling signal comprising an indication of a serving rate for the communication path between the sender 200 and the receiver 300. The serving rate for the sender-receiver pair 600 is derived by using the first parameter of the first signal.

This signaling can be used by suitable transport protocols to adjust the sending rate. Since one objective of the present application is to support various applications and transport protocols this signaling may be optionally used by the sender-receiver pair 600. In particular, transport protocols that rely on explicit feedback of transmission rates from the network nodes can be supported efficiently. This signaling may be implemented by lower layer protocols, to indicate the signaling rates in a local network. This is particularly useful when the scheduler 100 is located in an access network.

The sender 200 receives the scheduling signal from the scheduler and transmits data packets to the receiver over the communication path at the serving rate signaled by the scheduler.

In most embodiments the sender 200 is responsible for setting and adjusting the sending rate for the sender-receiver pair. It is therefore a preferred embodiment that the sender 200 transmits the congestion metric signaling to the scheduler 100, and receives the serving rate signaling from the scheduler 100. In one embodiment the sender 200 is directly connected to the network node with the present scheduler 100, so that the scheduler can signal the indication of the sending rate directly to the sender using link layer signaling.

In another embodiment of the present application the scheduler 100 receives a second signal comprising at least one second parameter which is a channel quality parameter associated with the communication link for the sender-receiver pair 600. The scheduler can thus use both the first and the second parameters when scheduling the resources of the communication link.

Hence, to increase the spectrum efficiency the scheduler 100 may also take the channel quality of the users into account. An example embodiment of the scheduler (in the single bottleneck case) that use both the signaled credits and the channel quality of each user may allocate resources to user i proportional to: Ri=Cri*Seîb/sum_j(Crj*Seĵb), where Cri is the excess congestion credit signaled by user i, Sei is the estimated spectral efficiency or the channel quality of user i, and b is a parameter that determines how much weight the scheduler gives to the channel quality. A higher value for b results in higher spectral efficiency and therefore throughput of the system at the cost of worse fairness between users with different channel qualities.

One problem often encountered is when the serving rate, throughput or packet delay of the communication path does not meet a corresponding threshold, such as serving rate threshold, throughput threshold or packet delay threshold. Therefore, in an embodiment of the sender 200 or the receiver 300 an additional first signal is transmitted to the scheduler 100. The additional first signal comprises at least one updated first parameter which may be determined based on a network policy of the network. Preferably, the network policy limits a total congestion volume of network traffic from the sender 200 or network traffic to the receiver 300 during a time period.

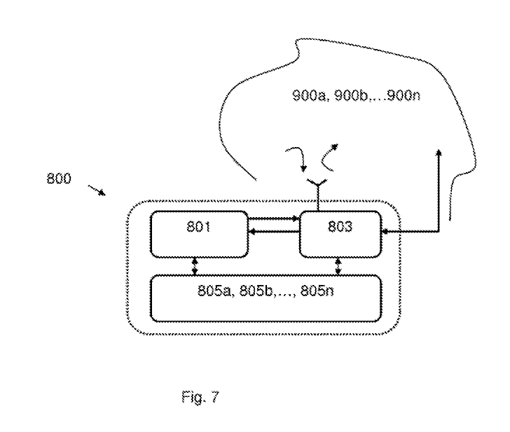

FIG. 7 shows a network node 800 according to an embodiment of the present application. The network node 800 comprises a processor 801 which is communicably coupled to a transmitter 803. The network node also comprises a plurality of queues 805a, 805b, . . . , 805n which are communicably coupled to the processor 801 and the transmitter 803. The plurality of queues 805a, 805b, . . . , 805n are configured to share common resources of a communication link for transmission of data packets to one or more receivers 900a, 900b, . . . , 900n. The processor 801 is configured to determine a first congestion level based on an utilization of the resources of the communication link, and to mark data packets of the plurality of queues 805a, 805b, . . . , 805n with a first marking based on the first congestion level. Hence, the first step of marking is performed for all data packets of the plurality of queues 805a, 805b, . . . , 805n. Thereafter, the processor for each queue determines a second congestion level for a queue 805n among the plurality of queues 805a, 805b, . . . , 805n based on a queue length of the queue 805n. Then the processor may either marks data packets of the queue (805n) with a second marking based on the second congestion level; or drops data packets of the queue 805n according to a probability based on the second congestion level. Finally, the transmitter transmits the data packets of the plurality of queues 805a, 805b, . . . , 805n to the one or more receivers 900a, 900b, . . . , 900n via the communication link, or transmits the data packets of the plurality of queues 805a, 805b, . . . , 805n, which have not been dropped, to the one or more receivers 900a, 900b, . . . , 900n via the communication link

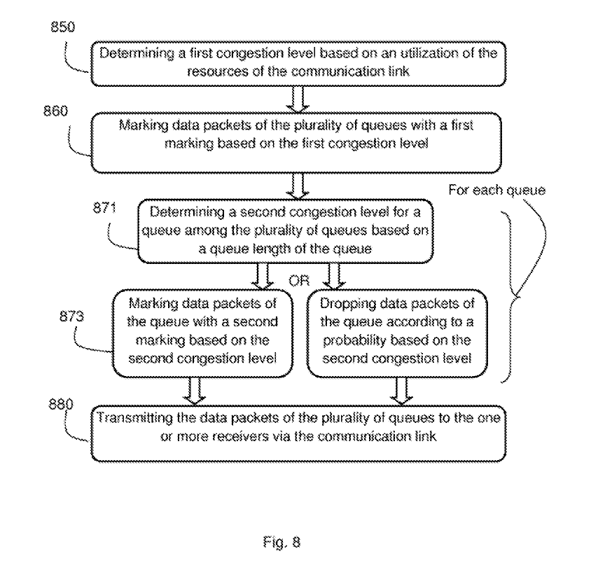

FIG. 8 shows a corresponding method in a network node according to an embodiment of the present application. At step 850 a first congestion level based on a utilization of the resources of the communication link is determined. At step 860 data packets of the plurality of queues 805a, 805b, . . . , 805n are marked with a first marking based on the first congestion level. For each queue 805n at step 871 a second congestion level for a queue 805n among the plurality of queues 805a, 805b, . . . , 805n is determined based on a queue length of the queue 805n. For each queue 805n at step 873 data packets of the queue 805n are marked with a second marking based on the second congestion level; or data packets of the queue 805n are dropped according to a probability based on the second congestion level. Finally, the data packets of the plurality of queues 805a, 805b, . . . , 805n are transmitted to the one or more receivers 900a, 900b, . . . , 900n via the communication link; or the data packets of the plurality of queues 805a, 805b, . . . , 805n, which have not been dropped, are transmitted to the one or more receivers 900a, 900b, . . . , 900n via the communication link.

According to the present network node 800, one explicit congestion marking, e.g. ECN marking, will be applied according to a function of the congestion level of the shared communication resources of all the plurality of queues (first marking), but not as a function of each separate queue (second marking or dropping of data packets), i.e. self-inflicted congestion. For self-inflicted congestion, in user specific queues, separate congestion marking can be used for the individual user queues, either another explicit signal or implicit signals such as packet delay or packet loss. An advantage of this is that the end host can react in different ways to congestion marking for self-inflicted and shared congestion, and apply control algorithms to achieve both latency and throughput goals.

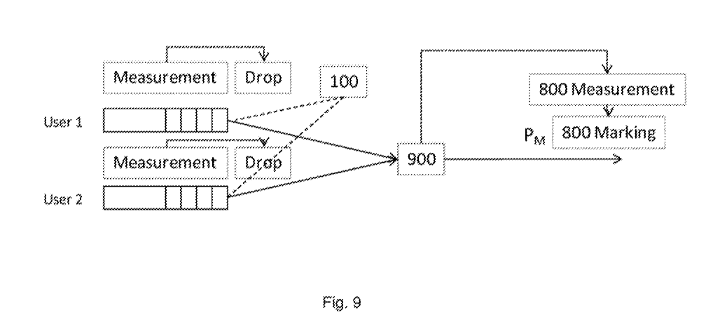

FIG. 9 shows an example of how the congestion marking can be generated in a network node 800 with multiple user or flow specific queues. A measurement function is associated with each user specific queue, to measure the length of the queue, and in some cases also calculate functions of the queue length, for example average and other statistics. Marking or drop function uses the measurement output for each queue to generate the user specific congestion signal by marking or dropping the packets. The marking function or drop function is typically a stochastic function of the queue length. The congestion levels are signaled to the receiver 300 either explicitly by marking of the packets or implicitly, e.g. as packet drops as illustrated in FIG. 9.

The usage of the shared communication link 900 is measured by another measurement function, which provides input to another marking function that generates a congestion signal related to the congestion or load of the shared communication link 900. As an example the marking function can use Random Early Detection (RED), where packets are marked with probabilities that are linearly increasing with the average queue length, and where the queue length from the measurement function can be generated by a virtual queue related to the shared communication link 900. The virtual queue would count the number of bytes of data that are sent over the shared link as the input rate to the queue and use a serving rate that is configured to generate a suitable load of the shared link, this will result in a virtual queue length that varies over time. The marking probability is the same for all users and it is denoted by P_{M} in FIG. 9.

The congestion control algorithms of a transport protocol can be designed with first (related to all data packets) and second marking (related to data packets of each queue). Having the two congestion markings should make it possible for the transport protocol to estimate how much congestion is self-inflicted (in particular in user specific queues), and how much is shared congestion.

The transport protocol can make use of this information by applying a combination of two different control actions. One is to change the sending rate, and the second is to change the transmitted congestion credit. Network nodes in the network can observe the congestion credit markings as well as the congestion marks and congestion re-echo marks. The possibility to observe the marking enables traffic management based on the congestion, for example by limiting the amount of congestion each user cause by implementing policing and auditing functions that inspect the marking.

The proposed solutions shall allow a range of different transport protocols to use the network in a fair and efficient manner. Therefore, it is not intended that a certain type of congestion control algorithm shall be mandated. However, a self-clocking window based congestion control algorithm as a typical example is considered. This means that the sender 200 is allowed to have as much data as indicated by the congestion window transmitted and not acknowledged, and new transmissions are sent as acknowledgements arrive. The congestion window is adjusted based on the congestion feedback signals to achieve a high utilization of the network without excessive queuing delays or losses. The sending rate would be approximately equal to a congestion window divided by the RTT. The congestion window would be set according to both the self-inflicted congestion and the shared congestion.

The congestion window could be updated as follows at time instance t according to Cw(t)=min(Cw(t−1)*beta1*(1+(C_limit−x(t−1)*cong_p1(t))/x(t−1)), Cw(t−1)*beta2*(1+(Delay_th−cong_p2(t)); where Cw(t−1) is the congestion window before the update, x is the transmission rate, beta1 and beta2 are control gain parameters, C_limit indicates the acceptable congestion volume of the user, cong_p1 is an estimate of the shared congestion level based on the feedback signal of the first marking, Delay_th is a threshold on the acceptable delay and cong_p2 is an estimate of a second congestion level that is proportional to the delay. In some embodiments, cong_p2 may be an estimate of the queuing delay of the communication path.

It should be noted that the congestion estimates may be filtered in the receiver 300. Different filter parameters for the two congestion level estimates can be used to achieve a partial decoupling of the control into different time scales, for example it may be preferred to use a slower control loop for the shared congestion level, depending on how fast and accurate the signaling of congestion credits is. The congestion feedback may also be filtered in the network, for example by AQM algorithms, or congestion may be signaled immediately without any averaging, as for datacenter TCP (DCTCP).

The proposed solution is not limited to any specific definition or implementation of the congestion marking function. However, an important constraint on the congestion control algorithm is that it shall work well when there is a shared queue at the bottleneck link, which should result in a very high correlation between the first and the second congestion levels and therefore also the first marking and the second marking or dropping. Differences between the estimated congestion levels can occur due to different parameters of the measurement and marking functions however, which needs to be considered in the implementation. Here it is implicitly assumed that the updates of the congestion window are made periodically, although it should be clear that the updates can also be made every time feedback is received from the receiver 300. The beta1 and beta2 parameters may need to be adapted to have a suitable gain for the specific feedback intervals.

A second control law may be applied to determine the feedback of congestion credits according to

if (x(t−1)<Rate_targ)

credit(t)=C_limit;

else

credit(t)=min(C_limit, x(t−1)*cong_p1(t));

end

where Rate_targ is the target rate of the user, x(t−1) is the transmission rate that was used in the period before the update, and credit(t) is the volume of credit that shall be signaled in the next period. The term x(t−1)*cong_p1(t) would be equal to the Re-echo metric here.

It should be noted that the first part of this control law may not be preferred in case the bottleneck does not increase the rate of the user based on the congestion credits and there is a value in saving congestion credits. This may for example be the case when a sender or receiver has multiple flows, and the admitted congestion volume has to be divided between the flows. However, as a simple example this algorithm works in many cases and can be used in more complex cases with an adaptive credit limit.

Other types of congestion control or rate control algorithms may be employed, for example for video streaming or similar applications. Such protocols may differ both in how the sending rate is adapted to the feedback, and how feedback is provided from the receiver 300 to the sender 200. For example Real Time Control Protocol (RTCP) tends to provide feedback less frequently than TCP.

In a shared queue, the congestion caused to other users and the self-inflicted congestion is identical, therefore the congestion control could use either of the first or second marking to estimate the congestion level when there is no bottleneck with user specific queues. When the bottleneck queue is shared there is also no possibility for each user to control both delay and rate, since there is no functionality in the network node that can allocate additional transmission capacity to a specific user or isolate the delays of different users.

One embodiment to calculate a congestion marking probability for the shared resources is to measure the usage of the transmission resources rather than queue levels. This may be implemented in the form of a virtual queue that calculates how much backlog of packets there would have been if the available capacity would have been at some defined value, which shall typically be slightly lower than the actual capacity. A marking function can then be applied to the virtual queue length. Since the actual capacity may vary, for example in the case of wireless channels, this can be a relatively simple way of calculating a congestion level. The congestion level could also be refined by dividing the virtual queue length with an estimate of the sending rate to generate an estimate of a virtual queuing time. For the shared resource the rate would be averaged over multiple users and the conversion to queuing time may therefore not be needed when there are many users sharing the resource. However, in case the number of users is low, it may be a preferred embodiment to calculate the shared congestion level as a virtual queuing time averaged over the active users. For example, in one cell of a cellular network a virtual queue could be implemented using a service rate which is some configured percentage of the nominal maximum throughput.

In another embodiment the marking function for the shared congestion level could be generated as a function of the overall queue levels of the user and class specific queues. In a node with a single priority level for all queues this could be achieved in different ways. One example is by applying AQM on the individual queues, and to use an average value of the marking probabilities of the individual queues. If the queues are using packet drops as congestion signal it may be preferred to use a different congestion calculation formula for the queues to determine the congestion marking level that is used in the averaging.

A second example is to use the total buffer occupancy of all the queues as input to the marking function. This may have the drawback that very long queues may contribute excessively to the marking probability, therefore the calculation of the marking probability should preferably use some function that increases slower than linearly with increasing individual queue lengths.

If there are multiple priority levels for different traffic classes the calculation of the shared congestion level depends on whether the congestion levels of the different classes shall be coordinated. A preferred way to coordinate is to define the congestion levels in the higher priority classes so that they reflect both the congestion in the own class and in the lower priority classes results in a marking that reflects the total contribution to the congestion of traffic in each class. This can be implemented with separate virtual queues for each class where queue levels or congestion levels of lower priority queues are fed to higher priority marking functions as illustrated in FIG. 3.

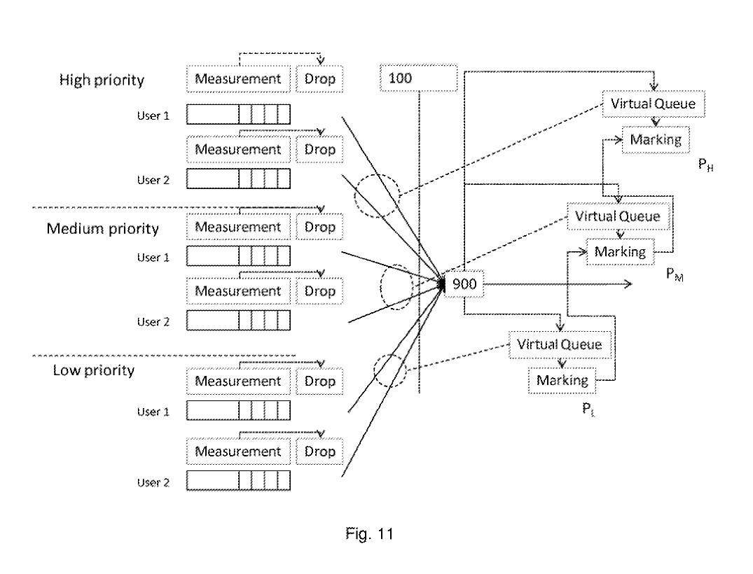

FIG. 11 shows an example of how the congestion signals can be generated in a network node with multiple user or flow specific queues in multiple priority classes. A measurement function (“Measurement” in FIG. 11) is associated with each user specific queue, to measure the length of the queue, and in some cases also calculate functions of the queue length, for example average and other statistics. A marking or drop function uses the measurement output for each queue to generate marks or drops according to the user specific congestion levels. The congestion signals are transmitted to the receiver either explicitly by marking of the packets or implicitly, e.g. as packet drops as illustrated in FIG. 11.

The shared communication link 900 has a limited capacity which is allocated to different users by a scheduler 100. The usage of the shared communication link 900 is measured by measurement functions for each priority class. In an embodiment based on virtual queues, each class would have its own virtual queue where the incoming rate would reflect the packets that shall be sent in that class. For the lower priority classes the virtual queues should use a virtual serving rate that takes into account the actual capacity left over when the higher capacity classes have been served. The virtual queues provide input to class specific marking functions that generate congestion signals related to the congestion or load in that class at the shared communication link 900. The lower priority classes implicitly take into account the load of the higher priority classes since the serving rate of the virtual queues are reduced when there is more traffic in higher priority classes. However, for the higher priority classes to take into account the congestion that is caused in lower priority classes there is a need for explicit information to be passed from lower priority marking functions to higher priority marking functions. The higher priority class traffic may be marked with a probability that is the sum of the marking probability of the next lower priority class and the marking probability that results from applying the marking function to the class specific virtual queue. Hence, the marking probabilities, P_{H} for the highest priority class, P_{M} for the medium priority class and P_{L} for the lowest priority class in the three classes in FIG. 11 always have the relation P_{H}≧P_{M}≧P_{L}

As an example the measurement function may be implemented as a virtual queue that calculates a virtual queue length that would result for the same traffic input with a service rate that is a fraction of the shared communication link 900 capacity. The marking function can be a random function of the virtual queue length.

However, in another embodiment the shared congestion levels can also be defined independently in each class, which means that the usage policies of different classes can also be independent. In the case of independent classes the same congestion marking functions as in the single class case can be deployed, using the resources that are allocated and the traffic transmitted in a single class to calculate the related congestion level.

The advantage of coupling the congestion levels of the different priority classes is that it allows a unified traffic management based on congestion volumes. The users can therefore prioritize and mark traffic for prioritization within the network without requiring resource reservation and admission control. The traffic sent in higher priority classes would be congestion marked with higher probability and therefore less traffic could be sent if a user selects a higher priority level. The marking at the lowest priority class can work as in the independent case, while the shared congestion at the next higher class should be based on the congestion marking probability in the lower class plus the shared marking probability in the own class.

In yet another embodiment the congestion level can be calculated as a function of the percentage of the resource blocks that are being used for transmission. In particular the marking function may use different weights for the resources that are used to serve different classes, such that the congestion metric is higher the more traffic is served in the higher priority classes.

The packet marking rate of each user may also be weighted according to some measure of the spectral efficiency of each user to provide a more accurate mapping of the resource consumption to the transmitted data volume and resulting congestion volume.

In one embodiment the current application is deployed locally in an access network, instead of being implemented end-to-end, which has the advantage that the solution is easier to deploy while still providing benefits. In this case the sender and the receiver may be gateways, access nodes or user devices in an access network. The connections may be between gateway and user device (in either direction), with an access node as intermediary node implementing a scheduler 100. The sending node 200 may use delay and rate thresholds for each user as input to the local traffic control algorithms. These thresholds may come from QoS management entities such as the Policy and Charging Control (PCC). They may also be derived from signaling of quality of service parameters through protocols like Session Initiation Protocol (SIP) or Resource Reservation Protocol (RSVP). The congestion credits for each user may be derived from user subscription information together with usage history of each user, for example some averaged value of the congestion volume a user has contributed to in the previous seconds or minutes. This has the advantage that the sending rates of users can be controlled over time with incentives to transmit that more of their data when they have a good wireless channel, while still providing fairness between users over time.

Furthermore, any method according to the present application may be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the present devices, network node device and user device, comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors of the present scheduler, sender, receiver and network nodes, may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present application is not limited to the embodiments described above, but also relates to and incorporates all embodiments within the scope of the appended independent claims.

1. A scheduler (100) for scheduling resources of a communication link (900) shared by a plurality of sender-receiver pairs (600a, 600b, . . . , 600n), the scheduler (100) comprising a processor (101) and a transceiver (103); the transceiver (103) being configured to
receive a first signal from a sender-receiver pair (600), wherein the sender-receiver pair (600) comprises a sender (200) and a receiver (300), the first signal comprises at least one first parameter indicating a congestion metric for a communication path between the sender (200) and the receiver (300) of the sender-receiver pair (600), and wherein the communication link (900) is part of the communication path; and the processor (101) being configured to
schedule the resources of the communication link (900) based on the at least one first parameter.

2. Scheduler (100) according to claim 1, wherein the congestion metric is a congestion credit metric indicating an amount of congestion in the communication path accepted by the sender (200), or a congestion re-echo metric indicating congestion of the communication path between the sender (200) and the receiver (300).

3. Scheduler (100) according to claim 2, wherein the processor (101) further is configured to
schedule the resources of the communication link (900) based on a difference between the congestion credit metric and congestion re-echo metric.

4. Scheduler (100) according to claim 1, wherein each sender-receiver pair (600a, 600b, . . . , 600n) is associated with at least one transmission queue; and wherein the processor (101) further is configured to
schedule the resources of the communication link to transmission queues.

5. Scheduler (100) according to claim 4, wherein data packets of each transmission queue are associated with a bearer, a session or a flow, and wherein each bearer, each session and each flow have a priority class among a plurality of priority classes; and wherein the processor (101) further is configured to
schedule the resources of the communication link (900) based on the at least one first parameter and the priority classes.

6. Scheduler (100) according to claim 1, wherein the transceiver (103) further is configured to
transmit a scheduling information signal to the plurality of sender-receiver pairs (600a, 600b, . . . , 600n), wherein the scheduling information signal indicates that the scheduler (100) uses the at least one first parameter when scheduling the resources of the communication link (900).

7. Scheduler (100) according to claim 1, wherein the processor (101) further is configured to
derive a serving rate for the communication path based on the at least one first parameter; and the transceiver (103) further is configured to
transmit a scheduling signal to the sender (200), wherein the scheduling signal comprises an indication of the serving rate.

8. Scheduler (100) according to claim 1, wherein the transceiver (103) further is configured to
receive a second signal comprising at least one second parameter, wherein the at least one second parameter is a channel quality parameter associated with the communication link (900) for the sender-receiver pair (600); and wherein the processor (101) further is configured to
schedule the resources of the communication link (900) based on the at least one first parameter and the at least one second parameter.

9. A sender (200) or a receiver (300) of a sender-receiver pair (600), the sender (200) being configured to transmit data packets to the receiver (300) over a communication path via a communication link (900), wherein the communication link (900) is part of the communication path and shared by a plurality of sender-receiver pairs (600a, 600b, . . . , 600n), and wherein the resources of the communication link (900) is scheduled by a scheduler (100); the sender (200) or the receiver (300) comprising a processor (201; 301) and a transceiver (203; 303); the processor (201; 301) being configured to
monitor a congestion level of the communication path;
determine at least one first parameter based on the monitored congestion level, wherein the at least one first parameter indicates a congestion metric for the communication path; and the transceiver (203; 303) being configured to
transmit a first signal comprising the at least one first parameter to the scheduler (100).

10. The sender (200) or the receiver (300) according to claim 9, wherein the congestion metric is a congestion credit metric indicating an amount of congestion in the communication path accepted by the sender (200), or a congestion re-echo metric indicating end-to-end congestion of the communication path between the sender (200) and the receiver (300).

11. The sender (200) or the receiver (300) according to claim 9, wherein the transceiver (203; 303) further is configured to
transmit an additional first signal comprising at least one updated first parameter to the scheduler (100) if a serving rate, a throughput or a packet delay of the communication path does not meet a serving rate threshold, a throughput threshold or a packet delay threshold, respectively.

12. The sender (200) or the receiver (300) according to claim 11, wherein the processor (201; 301) further is configured to
determine the at least one updated first parameter based on a network policy, wherein the network policy limits a total congestion volume of network traffic from the sender (200) or network traffic to the receiver (300) during a time period.

13. The sender (200) according to claim 9, wherein the transceiver (203) further is configured to
receive a scheduling signal from the scheduler (100), wherein the scheduling signal comprises an indication of a serving rate for the communication path, and
transmit data packets to the receiver (300) over the communication path at the serving rate.

14. Method for scheduling resources of a communication link shared by a plurality of sender-receiver pairs (600a, 600b, . . . , 600n), the method comprising:
receiving (150) a first signal from a sender-receiver pair (600), wherein the sender-receiver pair (600) comprises a sender (200) and a receiver (300), the first signal comprises at least one first parameter indicating a congestion metric for a communication path between the sender (200) and the receiver (300) of the sender-receiver pair (600), and wherein the communication link (900) is part of the communication path; and
scheduling (160) the resources of the communication link (900) based on the at least one first parameter.

15. Method in a sender (200) or a receiver (300) of a sender-receiver pair (600), the sender (200) being configured to transmit data packets to the receiver (300) over a communication path via a communication link (900), wherein the communication link (900) is part of the communication path and shared by a plurality of sender-receiver pairs (600a, 600b, . . . , 600n), and wherein the resources of the communication link (900) is scheduled by a scheduler (100); the method comprising:
monitoring (250; 350) a congestion level of the communication path;
deriving (260; 360) at least one first parameter from the monitored congestion level, wherein the at least one first parameter indicates a congestion metric for the communication path; and
transmitting (270; 370) a first signal comprising the at least one first parameter to the scheduler (100).
